(19) United States
(12) Patent Application Publication
(10) Pub. No.: US 2007/0292187 A1
(43) Pub. Date: Dec. 20, 2007

(54) Image forming apparatus and image forming method

(75) Inventor: Eiichi Hanazato, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., TOKYO (JP)

(21) Appl. No.: 11/640,316

(22) Filed: Dec. 18, 2006

(30) Foreign Application Priority Data
Jun. 16, 2006 (JP) 2006-167424

(51) Int. Cl. B41J 15/00

(52) U.S. Cl. 400/613.2

(57) ABSTRACT

An image forming apparatus includes: conveyance part that conveys, along a conveyance path, continuous paper in which fold lines are disposed per constant size; a detector that is disposed in a detection position in the middle of the conveyance path and detects whether or not a fold line in the continuous paper at the detection position is a mountain fold or a valley fold; and a memory that stores predetermined numbers of conveyance steps per size of one sheet of the continuous paper, wherein a leading edge of the continuous paper is loaded to a preset reference position, the number of conveyance steps corresponding to the size of one sheet of the continuous paper is read from the memory, the continuous paper is conveyed by the number of conveyance steps, and the fold line is aligned with the detection position of the detector.

### BACKGROUND

(1) Technical Field

The present invention relates to an image forming apparatus and an image forming method.

(2) Related Art

Conventionally, among printers, a printer that prints continuous paper such as folded paper has been known.

### SUMMARY

According to an aspect of the present invention, there is provided an image forming apparatus including: conveyance part that conveys, along a conveyance path, continuous paper in which fold lines are disposed per constant size; a detector that is disposed in a detection position in the middle of the conveyance path and detects whether or not a fold line in the continuous paper at the detection position is a mountain fold or a valley fold; and a memory that stores predetermined numbers of conveyance steps per size of one sheet of the continuous paper, wherein a leading edge of the continuous paper is loaded to a preset reference position, the number of conveyance steps corresponding to the size of one sheet of the continuous paper is read from the memory, the continuous paper is conveyed by the number of conveyance steps, and the fold line is aligned with the detection position of the detector.

### BRIEF DESCRIPTION OF THE DRAWINGS

An exemplary embodiment of the invention will be described in detail based on the following figures, wherein:

FIG. 1 is an overall view showing the completion of auto-loading in a printer according to an exemplary embodiment of the invention;

FIG. 2 is an overall view showing the state of auto-loading in the printer according to the exemplary embodiment of the invention;

FIG. 3 is an overall view showing mountain/valley detection in the printer according to the exemplary of the invention;

FIG. 4 is a perspective view showing the folding of continuous paper according to the exemplary embodiment of the invention;

FIG. 5 is a block diagram showing a controller and the like according to the exemplary embodiment of the invention;

FIG. 6 is a diagram showing a table stored in a number-of-conveyance-steps memory housed in the controller of FIG. 5; and

FIG. 7 is a flowchart showing auto-loading according to the exemplary of the invention.

### DETAILED DESCRIPTION

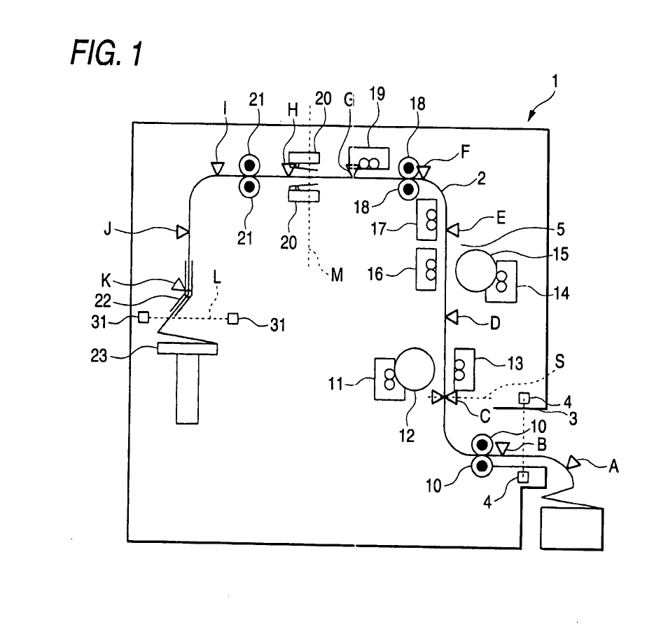

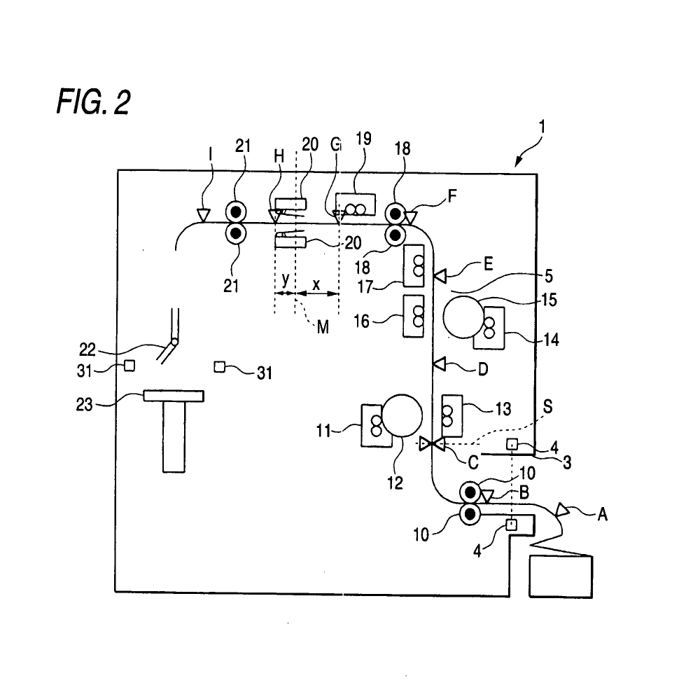

A printer according to an exemplary embodiment of the present invention will be described with reference to FIGS. 1 to 7.

As shown in FIG. 1, a printer 1 according to the exemplary embodiment of the present invention includes a substantially U-shaped conveyance path 5. Continuous paper 2, in which fold lines A to K that are perforated lines are disposed at constant intervals, is conveyed along the conveyance path 5 from a paper supply port 3 to a stacker 23. Sequentially disposed along the conveyance path 5, from the upstream side to the downstream side, are first conveyance rollers 10, a first developer 11, a first drum 12, a first transfer unit 13, a second developer 14, a second drum 15, a second transfer unit 16, a first fixer 17, second conveyance rollers 18, a second fixer 19, a mountain/valley detector 20, third conveyance rollers 21, a swing arm 22, and a stacker 23. The printer 1 also includes a controller 30 as shown in FIG. 5.

The first developer 11 and the first fixer 17 print the front side of the continuous paper 2, and the second developer 14 and the second fixer 19 print the back side of the continuous paper 2. Further, the first, second, and third conveyance rollers 10, 18, and 21 are driven by a stepping motor, for example, and configure conveyance parts for conveying the continuous paper 2 along the conveyance path 5.

The mountain/valley detector 20 is disposed between the third conveyance rollers 21 and the second fixer 19 along the conveyance path 5. When the continuous paper 2 reaches a detection position M of the mountain/valley detector 20, the mountain/valley detector 20 detects whether, for example, the fold line G in the continuous paper 2 is a mountain fold or a valley fold and outputs a detection signal to the controller 30.

A paper supply port sensor 4 is disposed in the paper supply port 3. When the continuous paper 2 is set in the paper supply port 3, the paper supply port sensor 4 detects whether or not the leading edge of the continuous paper 2 has been inserted into the paper supply port 3, outputs a detection signal to the controller 30, and causes the continuous paper 2 to be conveyed by the conveyance rollers 10, 18, and 21 along the conveyance path 5.

A stacker sensor 31 is disposed at a position in the vicinity of the stacker 23, which is a paper discharger. The stacker sensor 31 detects whether or not the leading edge of the continuous paper 2 conveyed along the conveyance path 5 has reached a reference position L in the vicinity of the stacker 23, outputs a detection signal to the controller 30, and causes the conveyance of the continuous paper 2 to be temporarily stopped.

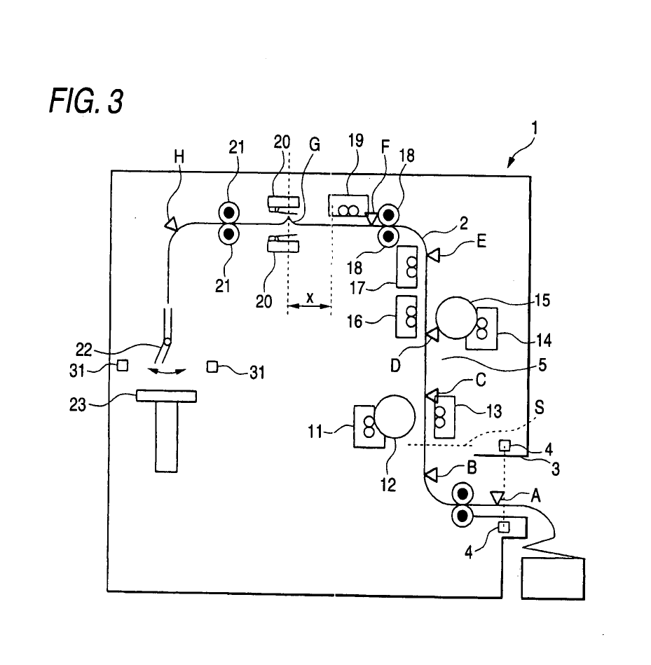

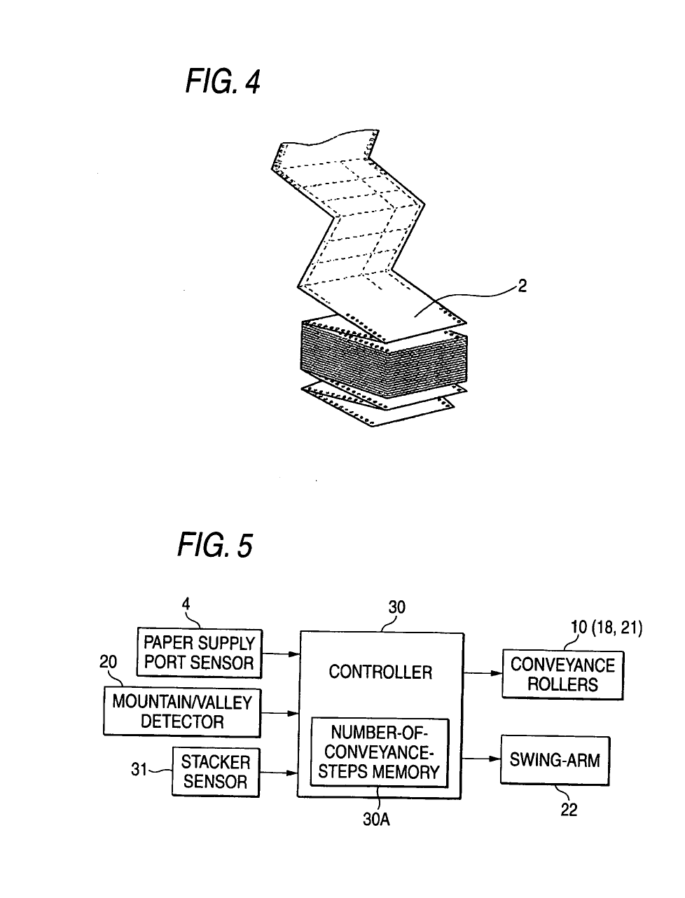

As shown in FIG. 5, the direction in which the swing arm 22 is to start swinging is determined on the basis of a signal outputted from the later-described controller 30. The swing arm 22 swings like a pendulum in the direction of the arrows shown in FIG. 3 in correspondence to the folding direction (mountain fold, valley fold) of the continuous paper 2 sequentially discharged toward the stacker 23, whereby the continuous paper 2 is methodically folded on the stacker 23 (see FIG. 4).

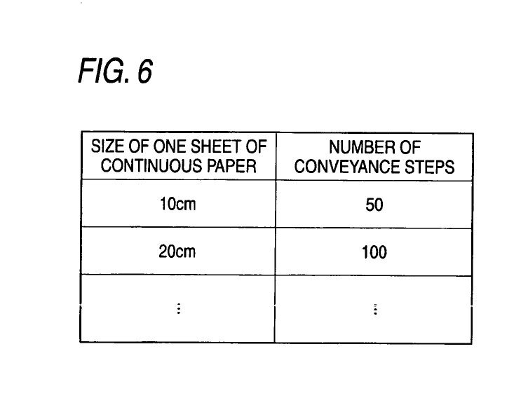

A number-of-conveyance-steps memory 30A is housed in the controller 30. As shown in FIG. 6, for example, a table of numbers of conveyance steps X that have been determined per size of one sheet of the continuous paper 2 is stored in advance in the number-of-conveyance-steps memory 30A. Here, the user uses a button (not shown) disposed on the printer 1 to input from the outside the size of the continuous paper 2 to be printed. Thus, the controller 30 reads, from the number-of-conveyance-steps memory 30A, one of the numbers of conveyance steps X corresponding to the size of the continuous paper 2 from among the numbers of conveyance steps X in the table shown in FIG. 6.

The controller 30 also controls the first, second, and third conveyance rollers 10, 18, and 21 on the basis of the read number of conveyance steps X, causes the continuous paper 2, whose leading edge has reached the position in the vicinity of the stacker 23 and which has been temporarily stopped, to be driven by the number of conveyance steps X by the conveyance rollers 10, 18, and 21, causes the continuous paper 2 to be conveyed such that, for example, the fold line G in the continuous paper 2 coincides with the detection position of the mountain/valley detector 20, and determines the direction in which the swing arm 22 is to start swinging.

Further, after the fold line G in the continuous paper 2 coincides with the detection position M of the mountain/valley detector 20 in this manner, the controller 30 causes the continuous paper 2 to be conveyed by the conveyance rollers 10, 18, and 20 by a length Y that is equal to the difference between the size of one sheet of the continuous paper 2 and the conveyance length resulting from the conveyance rollers 10, 18, and 21 corresponding to the number of conveyance steps X, causes the fold line B in the continuous paper 2 to coincide with a printing start reference position S, and sets such that printing can be conducted per one sheet of the continuous paper 2.

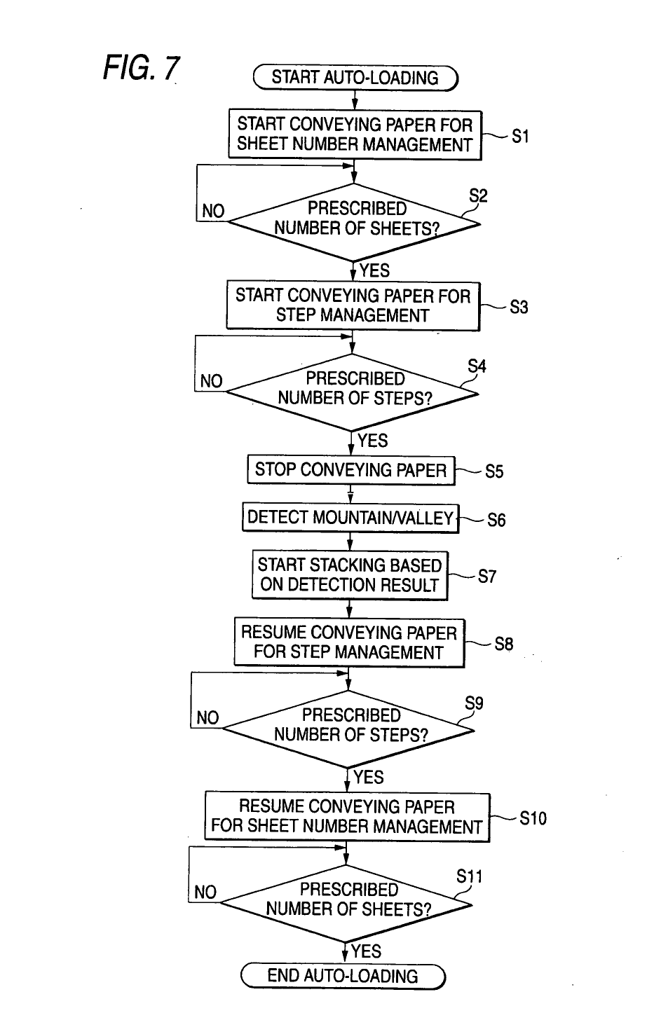

Next, the process of auto-loading from when the continuous paper 2 is set to when printing can be started in the printer 1 according to the exemplary embodiment will be described with reference to FIG. 7.

First, in step 1, the continuous paper 2 for sheet number management is set in the paper supply port 3, and the continuous paper 2 is conveyed along the conveyance path 5 by the conveyance rollers 10, 18, and 21 toward the stacker 23.

Next, in step 2, whether or not the number of conveyed sheets of the continuous paper 2 for sheet number management has reached a prescribed number (12 sheets in the exemplary embodiment) is determined on the basis of the number which is obtained to divide the length of the conveyance path 5 by the length of one sheet of the continuous paper 2. When the number of conveyed sheets has not reached the prescribed number (NO) then the processing of step 2 is repeated, and when the number of conveyed sheets has reached the prescribed number (YES), then the flow moves to step 3.

In step 3, conveyance of the continuous paper 2 for managing the number of conveyance steps X is started, and then the flow moves to step 4. Next, in step 4, it is determined whether or not the number of conveyance steps X of the continuous paper 2 resulting from the conveyance rollers 10, 18, and 21 has reached a prescribed number of steps. When the number of conveyance steps X has not reached the prescribed number of steps (NO), then the processing of step 4 is repeated, and when the number of conveyance steps X has reached the prescribed number of steps, that is, when the fold line G in the continuous paper 2 coincides with the detection position M of the mountain/valley detector 20 (YES, the state shown in FIG. 3), then the flow moves to step 5.

In step 5, the conveyance of the continuous paper 2 is temporarily stopped. Next, the flow moves to step 6, where the mountain/valley detector 20 detects whether the fold line G in the continuous paper 2 is a mountain fold or a valley fold. Next, the flow moves to step 7, where the initial swinging direction of the swing arm 22 (the direction in which the swing arm 22 is to start swinging) is determined on the basis of the detection result of the mountain/valley detector 20, and the swing arm 22 is caused to swing.

Next, in step 8, the continuous paper 2 is conveyed by the prescribed number of steps corresponding to the length Y that is equal to the difference between the size of one sheet of the continuous paper 2 and the length corresponding to the number of conveyance steps X resulting from the conveyance rollers 10, 18, and 21.

Next, the flow moves to step 9. When the number of steps for conveying the continuous paper 2 has not reached the prescribed number of steps (NO), then the processing of step 9 is repeated. When the number of steps has reached the prescribed number of steps (YES), that is, when the fold line C in the continuous paper 2 coincides with the printing start reference position S, then the flow moves to step 10, where the continuous paper 2 is again conveyed and printing of the continuous paper 2 is started. Next, the flow moves to step 11. When the number of conveyed sheets of the continuous paper 2 has not reached the prescribed number of sheets (NO), then the processing of step 11 is repeated. When the number of sheets has reached the prescribed number of sheets (YES), then auto-loading is completed and processing ends.

In this manner, in the exemplary embodiment, even when various kinds of the continuous paper 2 having a different size of one sheet are set to the printer 1 when the continuous paper is set, the fold line in the continuous paper 2 is aligned with the detection position of the mountain/valley detector 20 on the basis of the table stored in the number-of-conveyance-steps memory 30A of the controller 30, and in this state it can be detected whether or not the fold line is a mountain fold or a valley fold. Thus, the direction in which the swing arm 22 is to start swinging can be determined on the basis of the detection result of the mountain/valley detector 20.

Consequently, various kinds of the continuous paper 2 having a different size of one sheet can be loaded without the operator being aware of whether or not the first fold line in the continuous paper 2 is a mountain fold or a valley fold, and the convenience of the printer 1 can be raised.

It will be noted that, although an example is described in the exemplary embodiment where the continuous paper 2 is forwardly moved to align the fold line G of the fold lines A to K in the continuous paper 2 with the detection position of the mountain/valley detector 20, the present invention is not limited to this and may also be configured such that the continuous paper 2 is reversely moved (reversely conveyed) to align the fold line H in the continuous paper 2 with the detection position of the mountain/valley detector 20.

The foregoing description of the exemplary embodiment of the present invention has been provided for the purposes of illustration and description. It is not intended to be exhaustive or to limit the invention to the precise form disclosed. Obviously, many modifications and variations will be apparent to practitioners skilled in the art. The exemplary embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
conveyance part that conveys, along a conveyance path, continuous paper in which fold lines are disposed per constant size;
a detector that is disposed in a detection position in a middle of the conveyance path and detects whether or not the fold line in the continuous paper at the detection position is a mountain fold or a valley fold; and
a memory that stores predetermined numbers of conveyance steps per size of one sheet of the continuous paper,
wherein a leading edge of the continuous paper is loaded to a preset reference position, the number of conveyance steps corresponding to the size of one sheet of the continuous paper is read from the memory, the continuous paper is conveyed by the number of conveyance steps, and the fold line is aligned with the detection position of the detector.

2. The image forming apparatus according to claim 1, wherein a direction in which a folding mechanism of a stacker is to begin swinging is determined on the basis of the detection result of the detector.

3. The image forming apparatus according to claim 1, wherein after the detector detects whether or not the fold line in the continuous paper at the detection position is the mountain fold or the valley fold, the fold line in the continuous paper is conveyed to a position where an image is formed on the continuous paper.

4. An image forming method comprising:
conveying, along a conveyance path, continuous paper in which fold lines are disposed per constant size;
detecting whether or not a fold line in the continuous paper at a detection position is a mountain fold or a valley fold; and
storing predetermined numbers of conveyance steps per size of one sheet of the continuous paper in a memory, wherein a leading edge of the continuous paper is loaded to a preset reference position, the number of conveyance steps corresponding to the size of one sheet of the continuous paper is read from the memory, the continuous paper is conveyed by the number of conveyance steps, and the fold line is aligned with the detection position.

5. The image forming method according to claim 4, wherein a direction in which a folding mechanism of a stacker is to begin swinging is determined on the basis of the detection result.

6. The image forming method according to claim 4, wherein after detecting whether or not the fold line in the continuous paper at the detection position is the mountain fold or the valley fold, the fold line in the continuous paper is conveyed to a position where an image is formed on the continuous paper.
